(19) United States
(12) Patent Application Publication
(10) Pub. No.: US 2008/0254414 A1
(43) Pub. Date: Oct. 16, 2008

(54) DENTAL ABUTMENT BLANK WITH PREFORMED PASSAGE

(76) Inventors: JAMES A. McGUIRE, Irvine, CA (US); William Baker, Irvine, CA (US); Jason R. Taylor, Aliso Viejo, CA (US)

Correspondence Address: CHRISTIE, PARKER & HALE, LLP, PO BOX 7068, PASADENA, CA, 91109-7068, US

(21) Appl. No.: 12/101,111

(22) Filed: Apr. 10, 2008

Related U.S. Application Data
(60) Provisional application No. 60/911,050, filed on Apr. 10, 2007.

(51) Int. Cl. A61C 13/225

(52) U.S. Cl. 433/223; 433/172

(57) ABSTRACT

A dental blank has having a preformed passage configured to receive a dental screw fixation before or after milling by a CAD/CAM milling machine which can detect an exposed dental screw fixation or an exposed opening of the passage as a reference location. A method to provide a dental blank adapted for use as a reference location by a milling machine and/or a formation to facilitate a dental screw fixation to the blank, includes forming a blank and providing a passage through the blank, for example, by drilling.

### CROSS-REFERENCE TO RELATED APPLICATIONS

This application claims the benefit of U.S. Provisional Patent Application No. 60/911,050, filed Apr. 10, 2007, which is hereby incorporated by reference as if fully stated herein.

### FIELD OF INVENTION

The present invention relates to a dental abutment blank adapted for use with a dental implant, and a method of making the same.

### BACKGROUND OF INVENTION

Dental implants have been in use to replace natural teeth. Dental implants not only allow people to chew with comfort, but are an effective means to avoid loss of the bone in the jaw when dentition is lost. Different types of dental implants are known. In many cases, the dental implant includes a 3.5-5.5 mm metallic bone screw that serves as a tooth root, which is inserted surgically into the jawbone or upper maxillary. A cap, a bridge or denture (supporting an artificial crown(s)) can then be anchored to the implant by means of an abutment on which artificial teeth are placed. To make an artificial crown, a blank of suitable dental material is formed and milled to resemble a crown of the tooth being replaced. Typically, after the artificial crown has been milled, a connector is affixed in preparation for attachment to the abutment which has already been fixed to the patient's jaw or upper maxillary. However, difficulties have been encountered when affixing the connector to the artificial crown, particularly where the connector requires a deep hole to be drilled in the artificial crown. A dental blank is a relatively small object and a milled dental blank is an even smaller object. Moreover, precise and accurate drilling of the connector hole is often required to ensure proper fitting of the artificial crown in the patient's mouth, or at least to ensure the proper connection axis or angle between the implant and the abutment. Moreover, CAD/CAM milling machines, though well suited for milling a dental blank to great precision and accuracy, can pose a challenge for operators when the milling process is initiated. That is, the first contact between the drill bit and the dental blank if not executed properly can readily damage the dental blank. Therefore, there is a desire for a dental blank that facilitates centering and referencing for the milling machine to start the milling process in a known position, and to allow milling with the dental implant connector already affixed or mounted onto the blank.

### SUMMARY OF THE INVENTION

The present invention is directed to a dental abutment blank having a preformed passage that is adapted for use as a reference location by a milling machine and/or a formation to facilitate a dental connection to the blank prior to milling. The blank has at least one passage extending between two opposing ends of the blank. As a reference location, the passage is generally concentric or axially aligned with the blank. As a formation facilitating a dental screw fixation, the passage defines a dental connection axis in the blank.

In one embodiment, the blank has at least one passage that extends between two opposing ends. The passage includes a larger portion and a smaller portion which are configured to receive a connector such as dental screw fixation including a screw and a nut, for an internal mount or an external fixation on the blank. The blank may be mounted on a mandrel with the passage generally parallel (and coaxial) with the mandrel, or with the passage generally perpendicular to the mandrel. In any case, the blank provides an opening of the passage or an end of the affixed dental screw fixation that can be read, detected or sensed by a CAD/CAM machine for use as a reference location.

In a more detailed embodiment, the blank may have a cylindrical form or a rectangular solid form with one smaller end and one larger end with a tapered section adjacent the smaller end to better resemble the bottom or gumline of a crown. And depending on the type of dental screw fixation desired, the passage may have a longer narrower portion and a shorter wider portion, or a shorter wider portion and a longer narrower portion.

Accordingly, the present invention includes a dental blank having a generally solid form with two opposing ends, the block having a preformed passage extending between the two ends. The block may have a cylindrical form or a rectangular form. One of the ends may be smaller with an adjacent tapered section so that the blank better resembles a crown-like shape. The passage is configured to receive a dental screw fixation, which may include a screw and a nut. The dental screw fixation may be mounted to the blank in an external or an internal configuration. Either end of the block carrying the dental screw fixation is adapted for mounting to a mandrel prior to milling of the blank, to expose either the dental screw fixation or an opening of the passage distal to the mandrel. Once in a CAD/CAM milling machine, either the exposed dental screw fixation or the exposed opening of the passage is sensed as a reference location for locating the blank prior to milling.

A method to provide a dental blank adapted for use as a reference location by a milling machine and/or a formation to facilitate a dental screw fixation to the blank prior to milling, includes forming a blank and providing a passage through the blank, for example, by drilling. The method also includes providing such a passage prior to milling the blank and/or mounting the blank on a mandrel. The method further includes mounting a dental screw fixation in the passage to provide an internal or external connection for a dental implant, dental implant abutment or orthodontic implant prior to milling the blank and/or mounting the blank on a mandrel. The method further includes using the passage in the blank or a distal portion of the mounted dental screw fixation (e.g., a screw head and/or nut) as a reference location for milling the blank.

### BRIEF DESCRIPTION OF THE DRAWINGS

These and other features and advantages of the present invention will be better understood by reference to the following detailed description when considered in conjunction with the accompanying drawings wherein:

FIG. 1 is a perspective view of an embodiment of a preformed dental blank in accordance with the present invention.

FIG. 1A is a side elevational view of the dental blank of FIG. 1.

FIG. 2 is a perspective view of another embodiment of a preformed dental blank in accordance with the present invention.

FIG. 2A is a side elevational view of the dental blank of FIG. 2.

FIG. 3 is a side cross-sectional view of an embodiment of a dental blank in accordance with the present invention, with a dental screw fixation where the dental blank is mounted on an mandrel.

FIG. 3A is a side cross-sectional view of the dental blank of FIG. 3 after milling.

FIG. 4 is a side cross-sectional view of another embodiment of a dental blank in accordance with the present invention, with a dental screw fixation, where the dental blank is mounted on an mandrel.

FIG. 4A is a side cross-sectional view of the dental blank of FIG. 4 after milling.

FIG. 5 is a side cross-sectional view of another embodiment of a dental blank in accordance with the present invention, where the passage is generally perpendicular to the mandrel.

FIG. 6 is a side cross-sectional view of another embodiment of a dental blank in accordance with the present invention, where the passage is generally parallel, if not co-axial, with the mandrel.

FIG. 7 is a side cross-sectional view of another embodiment of a dental blank in accordance with the present invention, where the blank has a plurality of passages.

FIG. 7A is the dental blank of FIG. 7 after milling around one passage.

FIG. 8A is an enlarged cross-sectional view of an embodiment of a passage in accordance with the present invention.

FIG. 8B is an enlarged cross-sectional view of another embodiment of a passage in accordance with the present invention.

FIG. 9 is a perspective view of another embodiment of a preformed dental blank in accordance with the present invention.

FIG. 9A is another perspective view of the dental blank of FIG. 9.

FIG. 9B is a top view of the dental blank of FIG. 9.

FIG. 9C is an end view of the dental blank of FIG. 9.

FIG. 9D is a cross sectional view of the dental blank of FIG. 9C, taken along line A—A.

### DETAILED DESCRIPTION OF THE INVENTION

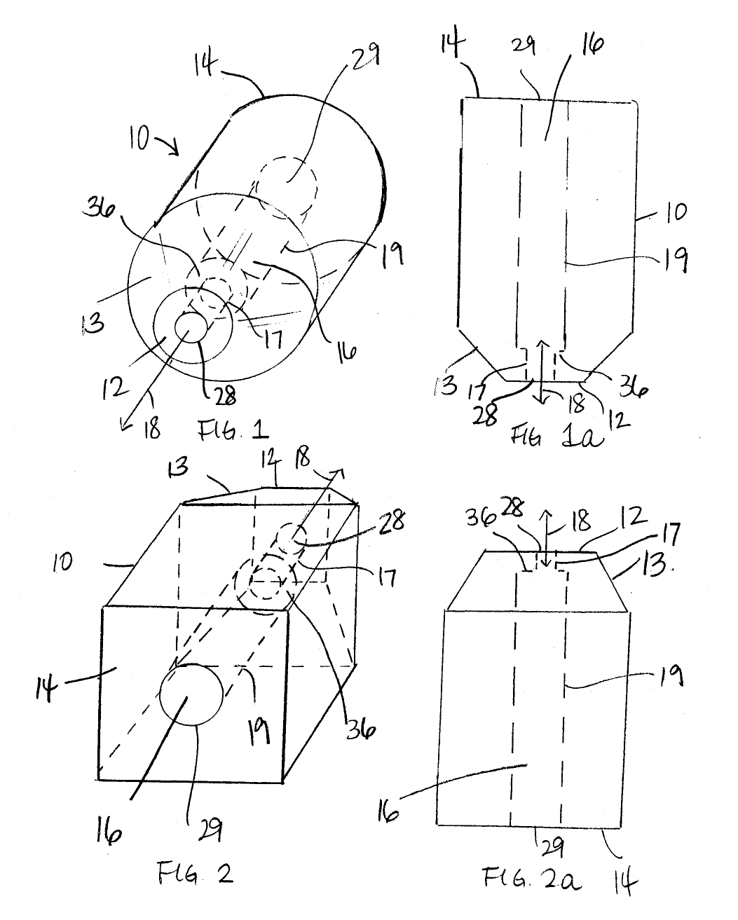

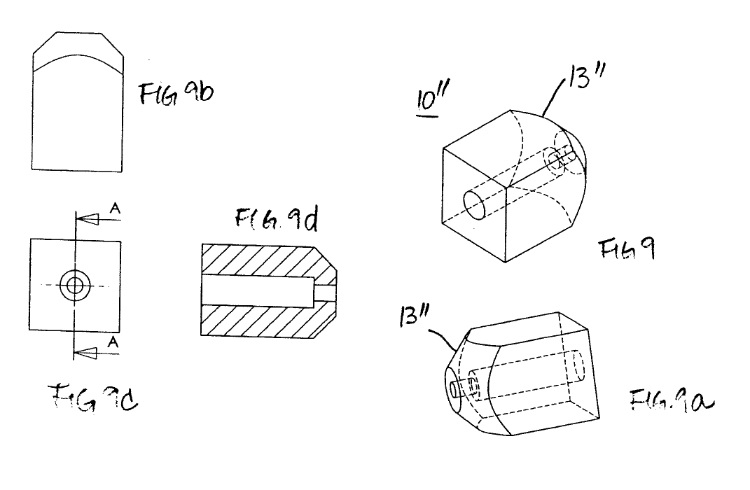

FIGS. 1, 1A, 2 and 2A illustrate embodiments of a dental blank in accordance with the present invention. The blank 10 is a solid form constructed of a machinable material suitable for dental applications, including ceramic, plastic, composite, hybrid of ceramic and resin and/or combination thereof. The blank 10 may have a generally circular-cross section such that the blank takes on a cylindrical form (FIGS. 1 and 1A), or the blank may have a generally rectangular or square cross section such that the blank takes on a rectangular block form (FIGS. 2 and 2A). In the illustrated embodiment of FIGS. 1 and 1A, the blank has two opposing ends 12 and 14. Adjacent the end 12 is a tapered section 13 with a decreasing diameter or cross section, whereas opposing end 14 has the same diameter or cross section as the bulk or main portion of the blank. As understood by one of ordinary skill in the art, the blank can assume a variety of different configuration as desired or appropriate, including a rectangular block form 10″ with a round tapered section 13″, as illustrated in FIGS. 9-9D.

In accordance with the present invention, the blank has a preformed passage 16 adapted for use as a reference location by a milling machine and/or a formation to facilitate a dental screw fixation to the blank prior to milling. In the latter regard, the passage 16 defines a connection axis 18 of the dental screw fixation. The passage or through-hole 16 traverses the blank and is in communication with the exterior of the blank via two openings 28 and 29. In the illustrated embodiments of FIGS. 1, 1A, 2 and 2A, the passage 16 extends between the ends 12, 14 and is generally concentric with the blank for use as a reference location, as discussed further below. The passage 16 may have any cross sectional shape, although it is generally circular where the passage is formed by drilling.

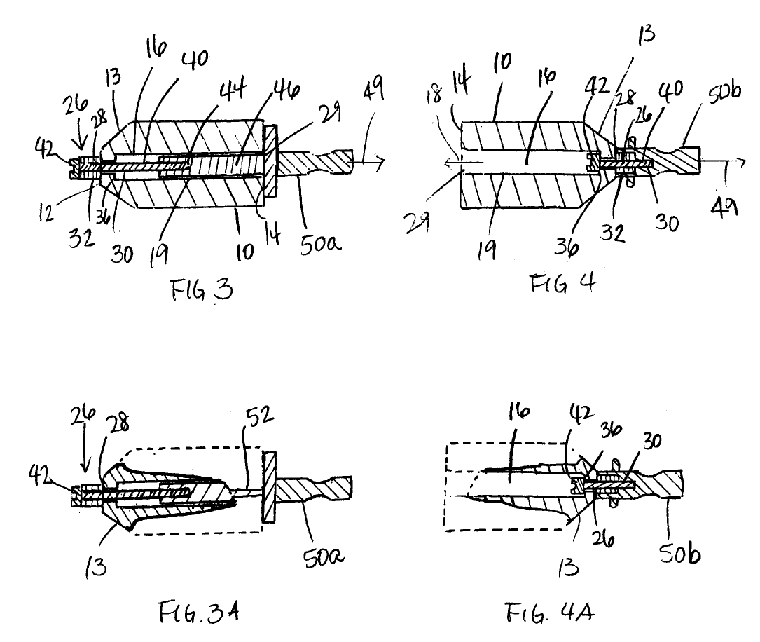

With further reference to FIGS. 3, 3A, 4 and 4A, to receive a dental screw fixation 26 that is a component of and/or is used for connection to a dental implant, dental implant abutment or orthodontic implant so that the blank may be used as a temporary or final implant abutment, the opening 28 and the passage 16 at the tapered section 13 is configured to receive a fixation screw 30 and nut 32, such as a hexagon nut. The opening 28 of the passage and an adjacent receiving portion 17 of the passage can be smaller than the opening 29 and a remainder portion of the passage 16. This configuration can be accomplished by the use of a smaller drill bit into the blank 10 in creating the smaller opening 28 and the smaller passage portion 17 and the use of a larger drill bit also into the blank 10 but from the opposite direction in creating the opening 29 and the larger passage portion 19. As understood by one of ordinary skill in the art, the depth to which each drill bit is advanced along the axis 18 into the blank toward each other to form a transition or neck 36 at the junction of passage portions 17 and 19 in the passage 16 is dependent on various factors, including the load that the tapered end 13 is expected to carry during milling of the blank and forces applied within a patient's mouth, and the length of the fixation screw 30.

As shown in FIGS. 3 and 3A, for mounting the fixation screw 30 for an external connection with the blank (of either a cylindrical or block form), a shaft 40 of the screw is inserted through the hex-nut 32 and into the opening 28 of the blank. The shaft 40 is inserted into the passage 16 until a head 42 of the screw abuts with the hex-nut 32 which in turn abuts with the end 12, and at least an end 44 of the screw shaft reaches or can be reached by a filler 46 occupying the passage portion 19 if not generally filling the passage 16. The filler may be a cement material, such as RelyX™ ARC Adhesive Resin Cement or Panavia™ 21. In this configuration, the fixation screw 30 points into the passage and is generally in alignment with the axis 18, where the screw head 42 is generally concentric with the blank 10 and the end 12. In accordance with a feature of the present invention, the blank 10 is advantageously equipped with the dental screw fixation prior to CAD/CAM milling, which avoids difficulties that are encountered when the screw fixation is affixed after the blank is milled. A milled shape of the blank is shown in FIG. 3A. As understood by one of ordinary skill in the art, sprue 52 connecting the milled blank to a mandrel 50 is removed after milling.

In the alternative embodiment of FIGS. 4 and 4A, where the fixation screw 30 forms an internal connection with the blank (with either a cylindrical or rectangular form), the fixation screw points in an opposite direction relative to the blank in that the screw points away from the passage 16 with the head 42 positioned within the passage 16. The screw head 42 abuts the neck 36 and the hex nut 32 is fastened on the screw shaft 30 outside tapered end 12 to secure the screw 26 to the blank 10.

In the embodiments of FIGS. 3, 3A, 4 and 4A, the hex nut 32 is exposed for attachment to a dental implant, dental implant abutment or orthodontic implant. It is understood by one of ordinary skill in the art that the passage opening 28 and the passage portions 17 and 19 are sized in accordance with the size or diameter of the fixation screw 26, the hex-nut 32 and/or the size of the blank 10. In the embodiment of FIGS. 3 and 3A, the cross section of the passage 16 may be sized in accordance with the size or diameter of the fixation screw shaft 30 and/or the amount of filler 46 suitable for anchoring the screw in the blank. In the embodiment of FIGS. 4 and 4A, the cross-section of the passage 16 should be sufficiently large to receive the screw head 42. Regardless of the embodiment, the opening 28 and passage 16 should permit the mounting and anchoring of the dental screw fixation without compromising the overall integrity of the blank needed to withstand the stress and strain of milling and the blank's ultimate use as an artificial tooth of a dental implant.

Once equipped with the dental screw fixation, the blank may be mounted on a mandrel in a variety of orientations. In the embodiment of FIGS. 3 and 3A, the end 14 with the opening 29 faces mandrel 50a and the end 14 is affixed to the mandrel by an adhesive, such as cement. In this orientation, the CAD/CAM milling equipment can be adapted to sense and locate the screw head 42 for calibrating and use as, for example, the (0, 0, 0) coordinate of an X-Y-Z coordinate system by which the milling equipment operates. In the embodiment of FIGS. 4 and 4A, the end 44 of the fixation screw is received by mandrel 50b of a suitable design such that the end 12 faces the mandrel, and the opening 29 at the end 14 can be sensed and located by the CAD/CAM milling equipment for calibration and designation as the (0,0,0) of an X-Y-Z coordinate system. In the embodiments of FIGS. 3, 3A, 4 and 4A, the passage 16 is generally coaxial with a longitudinal axis 49 of the mandrel.

FIGS. 3A and 4A illustrate suitable shapes (such as the illustrated “crown-resembling” shape) that can be produced by milling. In that regard, the tapered portion 13 of the blank reduces amount of the milling needed at what would be about the gumline area of the dental implant to achieve the illustrated crown-resembling shape. Any sprue connection, such as sprue 52, can be readily removed in the finishing process. In the embodiment of FIG. 4A, the passage 16 may be filled as suitable or appropriate after the blank has been milled.

The passage 16 regardless of its specific configuration can be formed with great care and accuracy in terms of its location and concentricity relative to the blank 10 so that the dental screw fixation or the passage can serve as a reference location for the CAD/CAM milling equipment. The size and dimensions of the passage 16 can be customized to fit the specific implant connection. Whether the blank construction material shrinks from firing or sintering or remains at size, the preformed passage facilitates the screw fixation between the blank and the dental device.

In accordance with a feature of the present invention, the passage 16 may be in any orientation relative to the mandrel 50 or its longitudinal axis 49. In the embodiment of FIG. 5, the blank 10 has sides 63, one of which is mounted onto the mandrel 50a such that the passage 16 (extending between ends 62) and the axis 49 of the mandrel are at generally right angles to each other. Such right angle orientation between the mandrel 50a and the connection axis 18 (as defined by the passage 16) may ease a bur approach geometry that is intended to avoid difficulties encountered when finishing the free end of the blank in an “on-axis” orientation (such as shown in FIG. 6). It is understood by one of ordinary skill in the art that where the blank is a generally rectangular solid or a cube (such as in FIGS. 5, 6 and 7), any difference between the sides and the ends of the blank is more semantic in nature than structural. As such, the terms “ends” and “sides” are used interchangeably for such rectangular solid or cube blanks. The point is that the passage or connection axis of the blank may be parallel, perpendicular or for that matter, any angle, relative to the axis of the mandrel, while allowing the passage to serve as a reference location by a milling machine and/or a formation to facilitate a dental screw fixation to the blank prior to milling. However, certain advantages and disadvantages may be associated with specific angles and ranges of angles as understood by one of ordinary skill in the art.

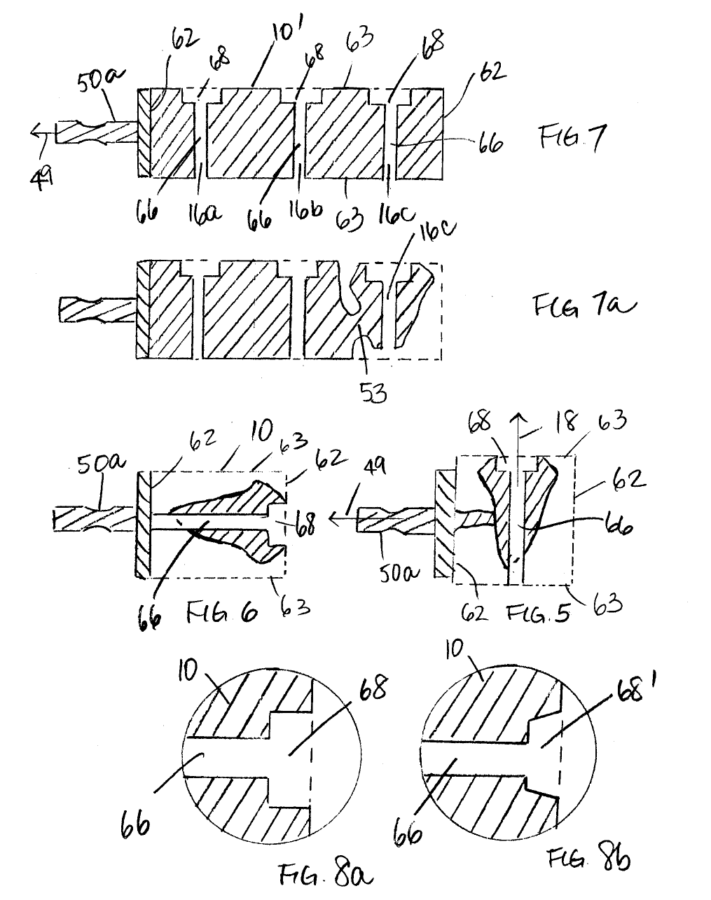

In accordance with another feature of the present invention, a blank may also be preformed with more than one passage. As shown in the alternative embodiments of FIGS. 7 and 7a, mounted on a mandrel 50a is an elongated blank 10′ with multiple passages 16i, for example, three passages 16a, 16b and 16c, each of which is generally perpendicular to the axis 49 of the mandrel. As illustrated in the embodiment of FIG. 7a, milling of the blank can therefore also be accomplished in this angle and configuration, where a sprue 53 is removed after the blank surrounding the passage 16c is milled.

While a feature of the present invention is directed to a preformed blank that is equipped with a dental fixation screw prior to milling, as illustrated in FIGS. 3, 3A, 4 and 4A, the present invention also contemplates a preformed blank that is milled without a dental fixation screw, as illustrated in FIGS. 5-8. As appropriate or desired, the dental fixation screw can be mounted to the preformed blank before or after milling.

In the embodiments of FIGS. 1-4, each passage includes the longer wider passage portion 19 that leads to the opening 28 and a shorter narrower passage portion 17 that leads to the opening 29. In the embodiments of FIGS. 5-7, each passage 16 includes a longer narrower passage portion 66 and a shorter wider passage portion 68. This configuration accommodates an embodiment of the dental screw fixation wherein the hex-nut is unexposed and positioned within the blank to sit in the passage portion 68. Moreover, the portion 68 may be cylindrical (FIG. 8a) or conical (FIG. 8b) depending on the shape of the hex-nut.

The present invention also includes a method for making a preformed blank adapted for use as a reference location by a milling machine and/or a formation to facilitate a dental screw fixation to the blank prior to milling. The method includes forming a blank and providing a passage through the blank, for example, by drilling. The method also includes providing such a passage prior to milling the blank and/or mounting the blank on a mandrel. The method further includes mounting a dental screw fixation in the passage to provide an internal or external connection for a dental implant, dental implant abutment or orthodontic implant prior to milling the blank and/or mounting the blank on a mandrel. The method yet further includes using the passage in the blank or the mounted dental screw fixation as a reference location for milling the blank.

As mentioned above, the passage can be formed by drilling along an axis from opposing directions, with a larger bit forming the wider passage portion and a smaller bit forming the narrower passage, where the extent or depth of drilling each or both bits determines the location of the transition or neck between the wider passage portion and narrower passage portion.

Prior to firing the blank, the passage may be oversized by a range of about 22% to 25% of the desired end dimensions. After the blank is fired to an intermediate density (where the passage may still be oversized by approximately a range of about 20%-25%), the blanks are mounted onto the mandrels in the desired orientation. As understood by one of ordinary skill in the art, the blank is milled, for example by CAD/CAM milling equipment, and the sprue is cut-off or otherwise removed. The milled blank (also known as an abutment) is hand finished and then fired to full density and final size, whereupon a coping/crown or framework/bridge is created for the abutment.

A suitable blank may be about 12 mm×14 mm×18 mm. The diameter of the passage may range between about 2.1 mm and 4.0 mm. For example, the narrower portion of the passage 16 may have a diameter of about 2.1 mm and the wider portion of the passage 16 may have a diameter of about 4.0 mm.

The preceding description has been presented with reference to presently preferred embodiments of the invention. Workers skilled in the art and technology to which this invention pertains will appreciate that alterations and changes in the described structure may be practiced without meaningfully departing from the principal, spirit and scope of this invention.

Accordingly, the foregoing description should not be read as pertaining only to the precise structures described and illustrated in the accompanying drawings, but rather should be read consistent with and as support to the following claims which are to have their fullest and fair scope.

What is claimed is:

1. A dental abutment blank adapted for milling on an mandrel, comprising:
a solid body with two generally opposing ends; and
a passage extending through the body between the opposing ends, the passage defining at least an opening at an end.

2. A dental abutment blank of claim 1, wherein the opening is adapted for use as a reference location by a computer-assisted design or computer-assisted manufacturing system during milling of the blank.

3. A dental abutment blank of claim 1, wherein the opening is adapted to receive a dental screw fixation.

4. A dental abutment blank of claim 3, wherein the end at the opening has a tapered configuration.

5. A dental abutment blank of claim 3, wherein the dental screw fixation includes a distal portion that is exposed when said dental screw fixation is mounted in the opening.

6. A dental abutment blank of claim 3, wherein the dental screw fixation includes distal portion that is positioned within the passage.

7. A dental abutment blank of claim 3, wherein the end opposing the opening is adapted for mounting on the mandrel.

8. A dental abutment blank of claim 3, wherein the dental screw fixation received in the opening is adapted for mounting on the mandrel.

9. A dental abutment of claim 1, wherein the solid body has a generally cylindrical shape.

10. A dental abutment of claim 1, wherein the solid body has a generally block shape.

11. A dental abutment blank comprising:
an elongated solid body adapted for mounting on a mandrel, the mandrel defining a longitudinal axis; and
a plurality of passages extending through the body, each of said passage being adapted to receive a dental screw fixation;
wherein the passages are generally perpendicular to the longitudinal axis of the mandrel.

12. A method for making a preformed blank adapted for milling on a mandrel, comprising:
forming a solid body;
a passage extending through the body, the passage defining at least an opening into the body;
mounting a dental screw fixation in the opening;
mounting the blank on the mandrel; and
milling the blank on the mandrel.

13. A method of claim 12, wherein the mounting a dental screw fixation in the opening is prior to milling the blank on the mandrel.

14. A method of claim 12, wherein the mounting a dental screw fixation in the opening is prior to the mounting the blank on the mandrel.

15. A method of claim 12, further comprising milling the blank mounted on the mandrel by using at least a portion of the dental screw fixation as a reference location.

16. A method of claim 12, wherein the passage defines a second opening at a second end and further comprising milling the blank mounted on the mandrel by using the second opening as a reference location.

17. A method of claim 13, wherein mounting the blank on the mandrel includes orienting the passage generally perpendicular to a longitudinal axis defined by the mandrel.

18. A method of claim 12, further comprising milling the blank mounted on the mandrel through computer-assisted design or manufacturing systems by using at least a portion of the dental screw fixation as a reference location.

19. A method of claim 12, wherein the mounting a dental screw fixation in the opening includes providing an external connection with the blank.

20. A method of claim 12, wherein the mounting a dental screw fixation in the opening includes providing an internal connection with the blank.
